(19) United States
(12) Patent Application Publication
(10) Pub. No.: US 2006/0250656 A1
(43) Pub. Date: Nov. 9, 2006

(54) Printing system, process, and product with a variable watermark

(75) Inventor: Thomas M. Plutchak, Hilton, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/122,592

(22) Filed: May 5, 2005

(51) Int. Cl. G06K 9/00; H04N 1/40

(52) U.S. Cl. 358/3.28

(57) ABSTRACT

A printing method, comprising marking an area of a receiver with a variable watermark marking material; and, marking in at least a portion of the area a security image with a second marking material, wherein the first and second marking material are configured such that the security image is variable.

### BACKGROUND OF THE INVENTION

The invention relates to printing of documents with security features.

Fraud associated with certain documents, for example bank checks, is an old and well known problem. Problems include alteration, counterfeiting, and copying (which may be included as a subset of counterfeiting). Various measures and associated technologies have been developed to protect against fraud. Examples include intricate designs, microprinting, colorshifting inks, fluorescent inks, watermarks, fluorescent threads, colored threads, holograms, foil printing, and others.

Efforts regarding such systems have led to continuing developments to improve their versatility, practicality and efficiency.

### BRIEF DESCRIPTION OF THE DRAWINGS

FIG. 1 presents a schematic diagram of an electrographic marking or reproduction system in accordance with the present invention.

FIG. 2 presents a schematic diagram of an electrographic marking or reproduction system in accordance with the present invention.

FIG. 3 presents an example of a development station implemented in the electrographic marking or reproduction system of FIG. 1.

FIG. 4 presents an artificial watermark in accordance with the invention.

### DETAILED DESCRIPTION

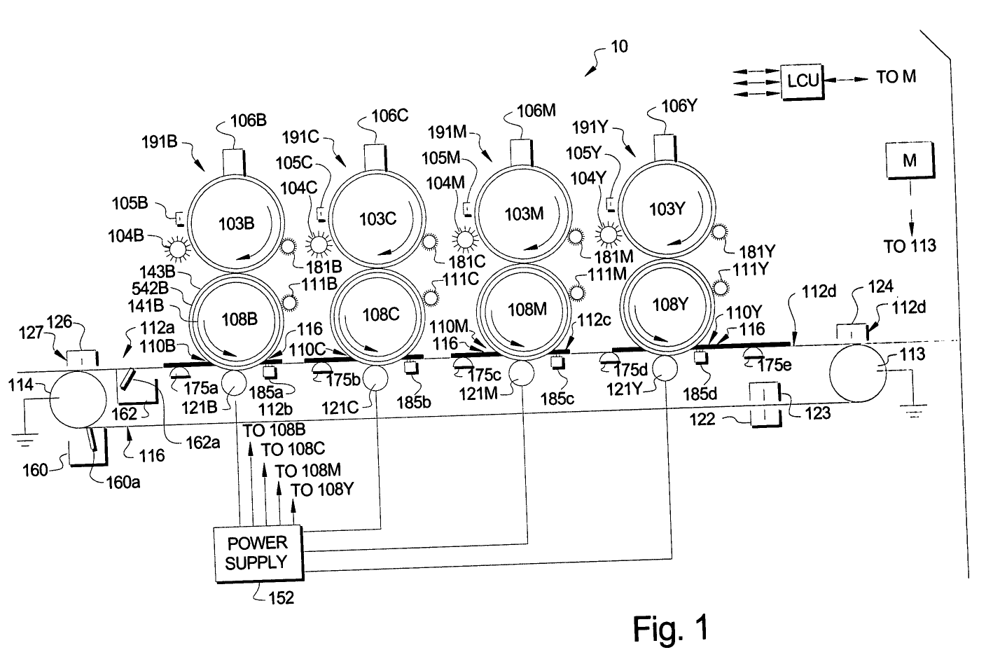

FIG. 1 illustrates an image forming reproduction apparatus or system according to an embodiment of the invention and designated generally by the numeral 10. The reproduction apparatus 10 is in the form of an electrophotographic reproduction apparatus and more particularly a color reproduction apparatus wherein color separation images are formed in each of four color modules (191B, 191C, 191M, 191Y) and transferred in register to a receiver member as a receiver member is moved through the apparatus while supported on a paper transport web (PTW) 116. More or less than four color modules may be utilized. For instance, the system may include a fifth color module or apparatus designated as F, thereby giving the print apparatus a CMYKF designation.

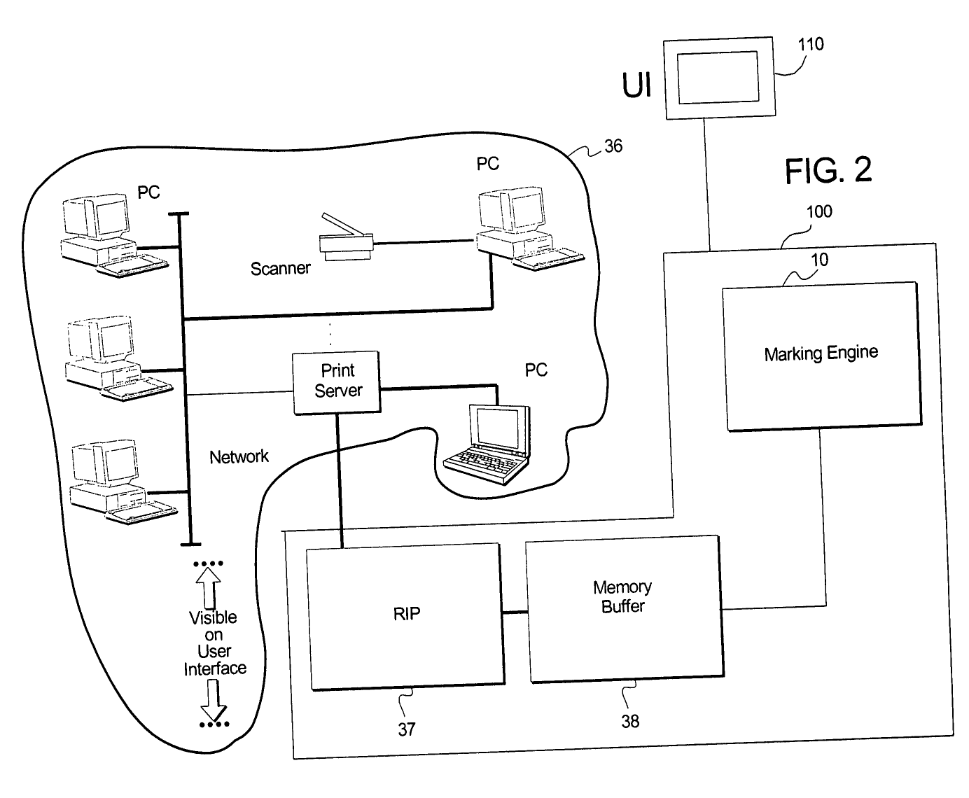

Each module is of similar construction except that as shown one paper transport web 116 which may be in the form of an endless belt operates with all the modules and the receiver member is transported by the PTW 116 from module to module. The elements in FIG. 2 that are similar from module to module have similar reference numerals with a suffix of B, C, M and Y referring to the color module to which it is associated; i.e., black, cyan, magenta and yellow, respectively. Four receiver members or sheets 112a, b, c and d are shown simultaneously receiving images from the different modules, it being understood as noted above that each receiver member may receive one color image from each module and that in this example up to four color images can be received by each receiver member. The movement of the receiver member with the PTW 116 is such that each color image transferred to the receiver member at the transfer nip of each module is a transfer that is registered with the previous color transfer so that a four-color image formed on the receiver member has the colors in registered superposed relationship on the receiver member. The receiver members are then serially detacked from the PTW and sent to a fusing station (not shown) to fuse or fix the dry toner images to the receiver member. The PTW is reconditioned for reuse by providing charge to both surfaces using, for example, opposed corona chargers 122, 123 which neutralize charge on the two surfaces of the PTW.

Each color module includes a primary image-forming member (PIFM), for example a rotating drum 103B, C, M and Y, respectively. The drums rotate in the directions shown by the arrows and about their respective axes. Each PIFM 103B, C, M and Y has a photoconductive surface, upon which a pigmented marking particle image, or a series of different color marking particle images, is formed. In order to form images, the outer surface of the PIFM is uniformly charged by a primary charger such as a corona charging device 105 B, C, M and Y, respectively or other suitable charger such as roller chargers, brush chargers, etc. The uniformly charged surface is exposed by suitable exposure means, such as for example a laser 106 B, C, M and Y, respectively or more preferably an LED or other electro-optical exposure device or even an optical exposure device to selectively alter the charge on the surface of the PIFM to create an electrostatic latent image corresponding to an image to be reproduced. The electrostatic image is developed by application of pigmented charged marking particles to the latent image bearing photoconductive drum by a development station 181 B, C, M and Y, respectively. The development station has a particular color of pigmented toner marking particles associated respectively therewith. Thus, each module creates a series of different color marking particle images on the respective photoconductive drum. In lieu of a photoconductive drum which is preferred, a photoconductive belt may be used.

Electrophotographic recording is described herein for exemplary purposes only. For example, there may be used electrographic recording of each primary color image using stylus recorders or other known recording methods for recording a toner image on a dielectric member that is to be transferred electrostatically as described herein. Broadly, the primary image is formed using electrostatography. In addition, the present invention applies to other printing systems as well, such as inkjet, thermal printing, etc.

Each marking particle image formed on a respective PIFM is transferred electrostatically to an outer surface of a respective secondary or intermediate image transfer member (ITM), for example, an intermediate transfer drum 108 B, C, M and Y, respectively. The PIFMs are each caused to rotate about their respective axes by frictional engagement with a respective ITM. The arrows in the ITMs indicate the directions of rotations. After transfer the toner image is cleaned from the surface of the photoconductive drum by a suitable cleaning device 104 B, C, M and Y, respectively to prepare the surface for reuse for forming subsequent toner images. The intermediate transfer drum or ITM preferably includes a metallic (such as aluminum) conductive core 141 B, C, M and Y, respectively and a compliant blanket layer 143 B, C, M and Y, respectively. The cores 141 C, M and Y and the blanket layers 143 C, M and Y are shown but not identified in FIG. 2 but correspond to similar structure shown and identified for module 191 B. The compliant layer is formed of an elastomer such as polyurethane or other materials well noted in the published literature. The elastomer has been doped with sufficient conductive material (such as antistatic particles, ionic conducting materials, or electrically conducting dopants) to have a relatively low resistivity. With such a relatively conductive intermediate image transfer member drum, transfer of the single color marking particle images to the surface of the ITM can be accomplished with a relatively narrow nip width and a relatively modest potential of suitable polarity applied by a constant voltage potential source (not shown). Different levels of constant voltage can be provided to the different ITMs so that the constant voltage on one ITM differs from that of another ITM in the apparatus.

A single color marking particle image respectively formed on the surface 142B (others not identified) of each intermediate image transfer member drum, is transferred to a toner image receiving surface of a receiver member, which is fed into a nip between the intermediate image transfer member drum and a transfer backing roller (TBR) 121 B, C, M and Y, respectively, that is suitably electrically biased by a constant current power supply 152 to induce the charged toner particle image to electrostatically transfer to a receiver sheet. Each TBR is provided with a respective constant current by power supply 152. The transfer backing roller or TBR preferably includes a metallic (such as aluminum) conductive core and a compliant blanket layer. Although a resistive blanket is preferred, the TBR may be a conductive roller made of aluminum or other metal. The receiver member is fed from a suitable receiver member supply (not shown) and is suitably “tacked” to the PTW 116 and moves serially into each of the nips 110B, C, M and Y where it receives the respective marking particle image in suitable registered relationship to form a composite multicolor image. As is well known, the colored pigments can overlie one another to form areas of colors different from that of the pigments. The receiver member exits the last nip and is transported by a suitable transport mechanism (not shown) to a fuser where the marking particle image is fixed to the receiver member by application of heat and/or pressure and, preferably both. A detack charger 124 may be provided to deposit a neutralizing charge on the receiver member to facilitate separation of the receiver member from the belt 116. The receiver member with the fixed marking particle image is then transported to a remote location for operator retrieval. The respective ITMs are each cleaned by a respective cleaning device 111B, C, M and Y to prepare it for reuse. Although the ITM is preferred to be a drum, a belt may be used instead as an ITM.

Appropriate sensors such as mechanical, electrical, or optical sensors described hereinbefore are utilized in the reproduction apparatus 10′ to provide control signals for the apparatus. Such sensors are located along the receiver member travel path between the receiver member supply through the various nips to the fuser. Further sensors may be associated with the primary image forming member photoconductive drum, the intermediate image transfer member drum, the transfer backing member, and various image processing stations. As such, the sensors detect the location of a receiver member in its travel path, and the position of the primary image forming member photoconductive drum in relation to the image forming processing stations, and respectively produce appropriate signals indicative thereof. Such signals are fed as input information to a logic and control unit LCU including a microprocessor, for example. Based on such signals and a suitable program for the microprocessor, the control unit LCU produces signals to control the timing operation of the various electrostatographic process stations for carrying out the reproduction process and to control drive by motor M of the various drums and belts. The production of a program for a number of commercially available microprocessors, which are suitable for use with the invention, is a conventional skill well understood in the art. The particular details of any such program would, of course, depend on the architecture of the designated microprocessor.

The receiver members utilized with the reproduction apparatus 10 can vary substantially. For example, they can be thin or thick paper stock (coated or uncoated) or transparency stock. As the thickness and/or resistivity of the receiver member stock varies, the resulting change in impedance affects the electric field used in the nips 110B, C, M, Y to urge transfer of the marking particles to the receiver members. Moreover, a variation in relative humidity will vary the conductivity of a paper receiver member, which also affects the impedance and hence changes the transfer field. To overcome these problems, the paper transport belt preferably includes certain characteristics.

The endless belt or web (PTW) 116 is preferably comprised of a material having a bulk electrical resistivity. This bulk resistivity is the resistivity of at least one layer if the belt is a multilayer article. The web material may be of any of a variety of flexible materials such as a fluorinated copolymer (such as polyvinylidene fluoride), polycarbonate, polyurethane, polyethylene terephthalate, polyimides (such as Kapton™), polyethylene napthoate, or silicone rubber. Whichever material that is used, such web material may contain an additive, such as an anti-stat (e.g. metal salts) or small conductive particles (e.g. carbon), to impart the desired resistivity for the web. When materials with high resistivity are used additional corona charger(s) may be needed to discharge any residual charge remaining on the web once the receiver member has been removed. The belt may have an additional conducting layer beneath the resistive layer which is electrically biased to urge marking particle image transfer. Also acceptable is to have an arrangement without the conducting layer and instead apply the transfer bias through either one or more of the support rollers or with a corona charger. It is also envisioned that the invention applies to an electrostatographic color machine wherein a generally continuous paper web receiver is utilized and the need for a separate paper transport web is not required. Such continuous webs are usually supplied from a roll of paper that is supported to allow unwinding of the paper from the roll as the paper passes as a generally continuous sheet through the apparatus.

In feeding a receiver member onto belt 116, charge may be provided on the receiver member by charger 126 to electrostatically attract the receiver member and “tack” it to the belt 116. A blade 127 associated with the charger 126 may be provided to press the receiver member onto the belt and remove any air entrained between the receiver member and the belt.

A receiver member may be engaged at times in more than one image transfer nip and preferably is not in the fuser nip and an image transfer nip simultaneously. The path of the receiver member for serially receiving in transfer the various different color images is generally straight facilitating use with receiver members of different thicknesses.

The endless paper transport web (PTW) 116 is entrained about a plurality of support members. For example, as shown in FIG. 1, the plurality of support members are rollers 113, 114 with preferably roller 113 being driven as shown by motor M to drive the PTW (of course, other support members such as skis or bars would be suitable for use with this invention). Drive to the PTW can frictionally drive the ITMs to rotate the ITMs which in turn causes the PIFMs to be rotated, or additional drives may be provided. The process speed is determined by the velocity of the PTW.

Alternatively, direct transfer of each image may be made directly from respective photoconductive drums to the receiver sheet as the receiver sheet serially advances through the transfer stations while supported by the paper transport web without ITMs. The respective toned color separation images are transferred in registered relationship to a receiver member as the receiver member serially travels or advances from module to module receiving in transfer at each transfer nip a respective toner color separation image. Either way, different receiver sheets may be located in different nips simultaneously and at times one receiver sheet may be located in two adjacent nips simultaneously, it being appreciated that the timing of image creation and respective transfers to the receiver sheet is such that proper transfer of images are made so that respective images are transferred in register and as expected.

In another embodiment, transfer of each image may be made from respective photoconductive drums to a continuous intermediate transfer web (CITW) as the CITW serially advances through the transfer stations. The respective toned color separation images are transferred in registered relationship to the CITW as the CITW serially travels or advances from module to module receiving in transfer at each transfer nip a respective toner color separation image. The registered color images on the CITW are subsequently transferred together in a single operation to a receiver sheet.

Other approaches to electrographic printing process control may be utilized, such as those described in international publication number WO 02/10860 a1, and international publication number WO 02/14957 A1, both commonly assigned herewith and incorporated herein by this reference.

Referring to FIG. 2, image data to be printed is provided by an image data source 36, which is a device that can provide digital data defining a version of the image. Such types of devices are numerous and include computer or microcontroller, computer workstation, scanner, digital camera, etc. Multiple devices may be interconnected on a network. These image data sources are at the front end and generally include an application program that is used to create or find an image to output. The application program sends the image to a device driver, which serves as an interface between the client and the marking device. The device driver then encodes the image in a format that serves to describe what image is to be generated on a page. For instance, a suitable format is page description language (“PDL”). The device driver sends the encoded image to the marking device. This data represents the location, color, and intensity of each pixel that is exposed. Signals from data source 36, in combination with control signals, provided to a printer or print system 100, which may include a raster image processor (RIP) 37 and a Marking Engine 10. Memory Buffer 38 and Marking Engine 10 may all be provided in single mainframe 100, having a local user interface 110 (UI) for operating the system from close proximity.

In general, the major roles of the RIP 37 are to: receive job information from the server; parse the header from the print job and determine the printing and finishing requirements of the job; analyze the PDL (page description language) to reflect any job or page requirements that were not stated in the header; resolve any conflicts between the requirements of the job and the marking engine configuration (i.e., RIP time mismatch resolution); keep accounting record and error logs and provide this information to any subsystem, upon request; communicate image transfer requirements to the marking engine; translate the data from PDL (page description language) to raster for printing; and support diagnostics communication between user applications. The RIP accepts a print job in the form of a page description language (PDL) such as postscript, PDF or PCL and converts it into raster, or grid of lines or form that the marking engine can accept. The PDL file received at the RIP describes the layout of the document as it was created on the host computer used by the customer. This conversion process is also called rasterization as well as ripping. The RIP makes the decision on how to process the document based on what PDL the document is described in. It reaches this decision by looking at the beginning data of the document, or document header.

Raster image processing or ripping begins with a page description generated by the computer application used to produce the desired image. The raster image processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the halftone processor renders the byte map into a bit map for use by the printer. Halftone densities are formed by the application of a halftone “screen” to the byte map, especially in the case of image objects to be printed. Pre-press adjustments can include the selection of the particular halftone screens to be applied, for example to adjust the contrast of the resulting image.

Electrographic printers with gray scale printheads are also known, as described in international publication number WO 01/89194 a2, incorporated herein by this reference. The halftoning algorithm groups adjacent pixels into sets of adjacent cells, each cell corresponding to a halftone dot of the image to be printed. The gray tones are printed by increasing the level of exposure of each pixel in the cell, by increasing the duration by way of which a corresponding LED in the printhead is kept on, and by “growing” the exposure into adjacent pixels within the cell.

Once the document has been ripped by one of the interpreters, the raster data goes to a page buffer memory (PBM) 38 or cache via a data bus. The PBM eventually sends the ripped print job information to the marking engine 10. The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the rip. Once the images are in memory, they can be repeatedly read from memory and output to the print engine. The amount of memory required to store a given number of images can be reduced by compressing the images; therefore, the images may be compressed prior to memory storage, then decompressed while being read from memory.

Page description language (PDL) specifies the arrangement of a printed page through commands from a computer that the printer carries out. Modern PDLs describe page elements as geometrical objects, such as lines, arcs, and so on. PDLs define page elements independently of printer technology, so that a page's appearance should be consistent regardless of the specific printer used. The printer itself (rather than the user's computer) processes much of the graphical information. For example, the printer carries out a command to draw a square or a character directly rather than downloading the actual bits that make up the image of the square or the character from the computer. The principal advantage of object-oriented (vector) graphics over bit-mapped graphics is that object-oriented images take advantage of high-resolution output devices whereas bit-mapped images do not. A PostScript drawing looks much better when printed on a 600-dpi printer than on a 300-dpi printer. A bit-mapped image looks the same on both printers. PDL defines a true computer programming language which is specifically designed to create and modify both text and graphic images, with full equality on a page at any resolution and in any color or density! Instead of sending raw text to the printer, a PDL program is created and sent to the printer. A specialized computer within the printer running a PDL interpreter program runs the supplied program to create the requested page image. The printer's drawing engine (the machinery that puts the black toner on the paper), then takes the image and draws it on the page. This is a different from formatting the page image on the host computer. It alleviates computer applications from worrying about creating page images since the image creation is actually done by the printer.

Structured PDL is an object oriented PDL containing structural information about each page. Structured PDL contains data structures which describe the page sizes and numbers of pages in the document. This information is readily accessible without having to process the PDL.

Unstructured PDL is a PDL not containing structural information about each page. Unstructured PDL describes the page sizes and numbers of pages in the document by having to process the PDL. Information on prior pages may cause information on the current page to change.

PDF is a file format developed for representing documents in a manner that is independent of the original application software, hardware, and operating system used to create those documents. A PDF file can describe documents containing any combination of text, graphics, and images in a device independent and resolution independent format. These documents can be one page or thousands of pages, very simple or extremely complex with a rich use of fonts. PDF makes it possible to keep the exact fonts, format, and layout of a document across any platform. PDF is a universal file format that preserves the fonts, images, graphics, and layout of any source document, regardless of the application and platform used to create it. used to capture almost any kind of document with the formatting as in the original. PDF is therefore an object oriented PDL containing structural information about each page. PDF contains data structures which describe the page sizes and numbers of pages in each document. PDF is an example of a structured PDL.

Further definition of PDF is found in “PDF Reference”, fifth edition, Adobe Portable Document Format, Version 1.6, Adobe Systems Incorporated, Addison Wesley (c) 1985-1999 Adobe Systems Incorporated, which is hereby incorporated herein by reference.

PostScript is a page description language developed and marketed which can be used by a wide variety of computers and printers, and is the dominant format used for desktop publishing. Documents in PostScript format are able to use the full resolution of any PostScript printer, because they describe the page to be printed in terms of primitive shapes which are interpreted by the printer's own controller. PostScript is often used to share documents on the Internet because of this ability to work on many different platforms and printers. The PostScript language is a programming language spoken by desktop software after the “print” command is issued. These PostScript instructions created by the software (in partnership with the printer driver) are sent to a PostScript laser printer to describe the page the user wishes to have output. The PostScript laser printer has an interpreter inside (called a RIP) that takes that page description and instructs the laser how to image the page. A language that is a text based description of a page that describes the appearance (text and graphics) of a printed page to control precisely how and where shapes and type will appear on a page. When a page of text and/or graphics is saved as a PostScript file, the page is stored as a set of instructions specifying the measurements, typefaces, and graphic shapes that make up the page. It is also an ISO standard. PostScript is an object-oriented language, meaning that it treats images, including fonts, as collections of geometrical objects rather than as bit maps. PostScript fonts are called outline fonts because the outline of each character is defined. They are also called scalable fonts because their size can be changed with PostScript commands. Given a single typeface definition, a PostScript printer can thus produce a multitude of fonts. In contrast, many non-PostScript printers represent fonts with bit maps. To print a bit-mapped typeface with different sizes, these printers require a complete set of bit maps for each size. PostScript is an example of Unstructured PDL.

Further definition of PostScript can be found in “PostScript Language Reference third edition”, Adobe Systems Incorporated, Addison Wesley (c) 1985-1999 Adobe Systems Incorporated

Raster image processing or ripping begins with a page description language (PDL format or document) generated by the computer application used to produce the desired image. The raster image processor interprets this PDL document into a display list of objects (Display Object format). This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Halftone densities are formed by the application of a halftone “screen” to the byte map, especially in the case of image objects to be printed. Pre-press adjustments can include the selection of the particular halftone screens to be applied, for example to adjust the contrast of the resulting image.

The digital print system quantizes images both spatially and tonally. A two dimensional image is represented by an array of discrete picture elements or pixels, and the color of each pixel is in turn represented by a plurality of discrete tone or shade values (usually an integer between 0 and 255) which correspond to the color components of the pixel: either a set of red, green and blue (RGB) values, or a set of yellow, magenta, cyan, and black (YMCK) values that will be used to control the amount of ink used by a printer.

The above description applies to discharge area development (DAD) systems, but could apply equally as well to charged area development (CAD) systems as well.

Once the document has been ripped by one of the interpreters, the raster data goes to a page buffer memory (PBM) 38 or cache via a data bus. The PBM eventually sends the ripped print job information to the marking engine 10. The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the rip. Once the images are in memory, they can be repeatedly read from memory and output to the print engine. The amount of memory required to store a given number of images can be reduced by compressing the images; therefore, the images may be compressed prior to memory storage, then decompressed while being read from memory. RIP 37, Memory Buffer 38, Render circuit 39 and Marking Engine 10 may all be provided in single mainframe 100, having a local user interface 110 (UI) for operating the system from close proximity.

As described hereinbefore, the RIP provides image data to a render circuit 39. The RIP 37, PBM 38 and render circuit 39 can be dedicated hardware, or a software routine such as a printer driver, or some combination of both, for accomplishing this task. The ripped data is provided to a writer driving controller.

Processes for developing electrostatic images using dry toner are well known in the art. The term “electrographic printer”, is intended to encompass electrophotographic printers and copiers that employ a photoconductor element, as well as ionographic printers and copiers that do not rely upon a photoconductor. Although described in relation to an electrographic printer, any printer suitable for digitally variable artificial watermarking may be implemented in the practice of the invention.

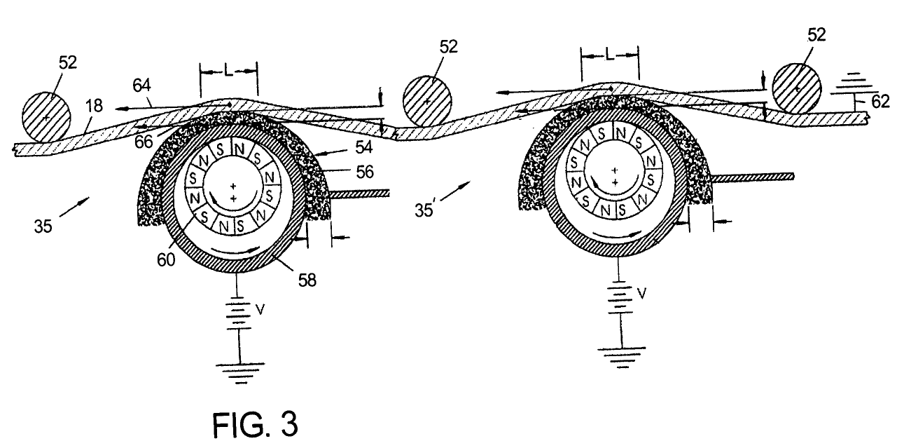

Referring now to FIG. 3, one embodiment of the development or toning stations 35, 35′ is presented. The development station 35 may comprise a magnetic brush 54 comprising a rotating shell 58, a mixture 56 of hard magnetic carriers and toner (also referred to herein as “developer”), and a rotating plurality of magnets 60 inside the rotating shell 58. The backup structure 35a of FIG. 1 is configured as a pair of backer bars 52. The magnetic brush 54 operates according to the principles described in U.S. Pat. Nos. 4,473,029 and 4,546,060, the contents of which are fully incorporated by reference as if set forth herein. The two-component dry developer composition of U.S. Pat. No. 4,546,060 comprises charged toner particles and oppositely charged, magnetic carrier particles, which (a) comprise a magnetic material exhibiting “hard” magnetic properties, as characterized by a coercivity of at least 300 gauss and (b) exhibit an induced magnetic moment of at least 20 EMU/gm when in an applied field of 1000 gauss, is disclosed. As described in the 060 patent, the developer is employed in combination with a magnetic applicator comprising a rotatable magnetic core and an outer, nonmagnetizable shell to develop electrostatic images. When hard magnetic carrier particles are employed, exposure to a succession of magnetic fields emanating from the rotating core applicator causes the particles to flip or turn to move into magnetic alignment in each new field. Each flip, moreover, as a consequence of both the magnetic moment of the particles and the coercivity of the magnetic material, is accompanied by a rapid circumferential step by each particle in a direction opposite the movement of the rotating core. The observed result is that the developers of the 060 flow smoothly and at a rapid rate around the shell while the core rotates in the opposite direction, thus rapidly delivering fresh toner to the photoconductor and facilitating high-volume copy and printer applications.

The electrostatic imaging member 18 of FIG. 3 is configured as a sheet-like film. However, it may be configured in other ways, such as a drum, depending upon the particular application. A film electrostatic imaging member is relatively resilient, typically under tension, and the pair of backer bars 52 may be provided that hold the imaging member in a desired position relative to the shell 18.

According to a further aspect of the invention, the process comprises moving electrostatic imaging member 18 at a member velocity 64, and rotating the shell 58 with a shell surface velocity 66 adjacent the electrostatic imaging member 18 and co-directional with the member velocity 64. The shell 58 and magnetic poles 60 bring the mixture 56 of hard magnetic carriers and toner into contact with the electrostatic imaging member 18. The mixture 56 contacts that electrostatic imaging member 18 over a length indicated as L. The electrostatic imaging member is electrically grounded 62 and defines a ground plane. The surface of the electrostatic imaging member facing the shell 58 is a photoconductor that can be treated at this point in the process as an electrical insulator, the shell opposite that is grounded is an electrical conductor. Biasing the shell relative to the ground 62 with a voltage V creates an electric field that attracts toner particles to the electrostatic image with a uniform toner density, the electric field being a maximum where the shell 58 is adjacent to the electrostatic imaging member 18. Toning setpoints may be optimized, as disclosed in U.S. Pat. No. 6,526,247, the contents of which are hereby incorporated by reference as if fully set forth herein. The magnetic core may have 14 magnets, a maximum magnetic field strength of 950 gauss and a minimum magnetic field strength of 850 gauss. At 110 pages per minute the ribbon blender may rotate 355 RPM, the toning shell may rotate at 129.1 RPM, and the magnetic core may rotate at 1141 RPM. At 150 pages per minute the ribbon blender may rotate 484 RPM, the toning shell may rotate at 176 RPM, and the magnetic core may rotate at 1555.9 RPM.

The mass velocity (also referred to as bulk velocity) may have flow properties as described in the U.S. Patent Publication 2002/0168200 A1, the contents of which are incorporated by reference as if fully set forth herein. In one embodiment, the developer is caused to move through the image development area in the direction of imaging member travel at a developer mass velocity greater than about 37% of the imaging member velocity. In another embodiment, the developer mass velocity is greater than about 50% of the imaging member velocity. In a further embodiment, the developer mass velocity is greater than about 75% of the imaging member velocity. In a yet further embodiment, the developer mass velocity is greater than about 90% of the imaging member velocity. In a still further embodiment, the developer mass velocity is between 40% and 130% of the imaging member velocity, and preferably between 90% and 110% of the imaging member velocity. In another embodiment, the developer mass velocity is substantially equal to the imaging member velocity.

One toning station may be utilized for marking a first material, and the other toning station may be utilized for marking a second material. For example, station 35 may be utilized to print text or graphics using normal colored toner (e.g. black), and station 35′ may be utilized to print watermarks or artificial watermarks. This arrangement could be reversed.

Watermarks are security features used frequently on checks, currency and many other security documents. They consist of images that are very faint or are only visible by transmission viewing. A true watermark is created during the paper manufacturing process. An artificial watermark is text, a logo, or a pattern printed on a document in a manner such that it is invisible, or nearly invisible, when viewed normally, i.e. when the document is held perpendicular to the line of sight. When the document is viewed at another angle, the text, logo, or pattern is human readable. Until now artificial watermarks have been commonly produced lithographically. In the present invention, the artificial watermark may be created by printing it with a clear dry ink (toner). When viewed at an angle, it is readilly human readable due to a differential gloss between the printed and non-printed areas. It is to be noted that the nature of the fusing roller surface may be important to achieving the desired result. For example, it may be preferred for the fusing roller surface to be relatively smooth.

Traditional watermarks protect against counterfeiting fraud in that the fraudster may not be aware of the presence of the watermark or may not have sufficient technology to produce the watermark. Watermarks are inherently static because of the production process, but the watermark is so faint that it is at least difficult if not impossible to copy. Watermarks and artificial watermarks may be be used in conjunction with other security features, such as intricate designs, microprinting, colorshifting inks, fluorescent inks, fluorescent threads, colored threads, security strips, holograms, foil printing, and many other features/technologies to thwart counterfeiting.

The toner for printing the variable artificial watermarks in accordance with the present invention may comprise a dry particulate thermoplastic material. The process for forming a particulate clear dry ink (toner) comprises, selecting a thermoplastic polymer selected from the group consisting of polyesters, polyamides, polyolefins, acrylic polymers and copolymers, methacrylic polymers and copolymers, styrenic polymers and copolymers, vinyl polymers and copolymers, and polyurethanes and combining the polymer with a charge agent. The charge agent can be any of a number of suitable charge agents, e.g. BONTRON® E-84, from Orient Corporation of America, Kenilworth N.J. The percent by weight of the charge agent can vary depending on the charge agent chosen. For the example charge agent (E-84) the percent by weight can be 0.5 to 5%, preferably 1 to 2.5%.

The combining step can be carried out using an extruder, a roll mill, or a kneading mill such as a Z-arm mixer at a selected temperature, preferably, about 80.degree. C. to about 160.degree. C., more preferably, about 120.degree. C.

Clear dry ink (toner) particles can be prepared from the clear dry ink (toner) composition using, for example, a jet mill pulverizer. The resulting toner particles have a volume median particle size, preferably, of about 4 microns to about 25 microns, more preferably, about 5 microns to about 12 microns, most preferably, about 6 microns to about 8 microns.

The clear dry ink (toner) particles formed by this process are useful for the development of latent electrostatographic latent images and can be advantageously employed to create artificial watermarks. They can also be advantageously employed in combination with yellow, magenta, cyan, and, optionally, black toner particles in a full color electrostatographic process. The clear dry ink (toner) particles can further be combined with toners of other colors, for example, orange, green, or purple, in pentachrome (five-color) or hexachrome (six-color) processes.

Other toners may be suitable in the practice of the invention. For instance, other clear or colored toners containing dyes sensitive to ultraviolet or infrared radiation and producing fluorescence when exposed to those radiations. Polyester based toners and styrene acrylate polymer based toners, for example, without limitation, as described in published U.S. Patent Applications 2003/0073017, 2003/0013032, 2003/0027068, 2003/0049552, and unpublished U.S. patent application Ser. Nos. 10/460,528—filed Jun. 12, 2003-“Electrophotographic Toner and Developer with Humidity Stability”, and Ser. No. 10/460,514—filed Jun. 12, 2003—“Electrophotographic Toner with Uniformly Dispersed Wax” may be implemented.

Printing machine 10 may have two available toning stations (35, 35′), with one toning station associated with special toner. It is of course contemplated that more than two toning stations may be available, each with their own associated optimal printing and process conditions. This description is based on a toning station having special watermark toner.

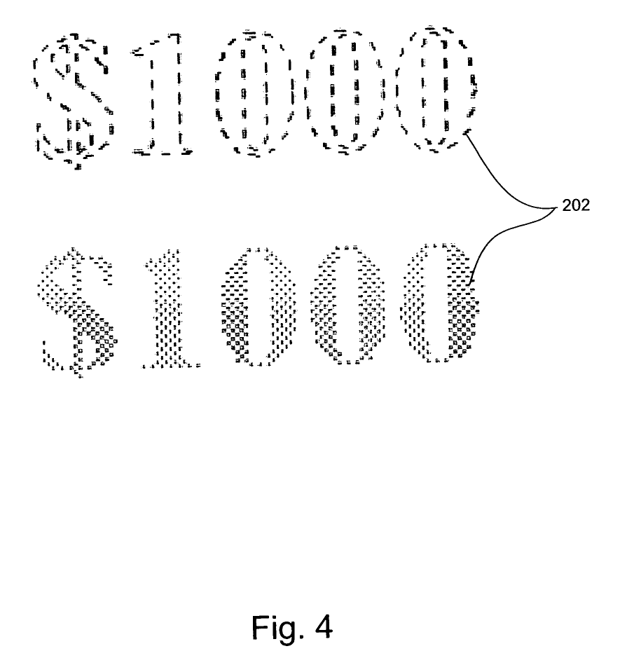

FIG. 4 illustrates an exemplary artificial watermark 202 which may be printed on a receiver, such as a check, bill, or other instrument such as a gift certificate. The variable information may be such things as the amount, the name, and the gift certificate number. The amount may be printed as a variable artificial watermark on both the front and the back. The certificate number may be printed as a variable artificial watermark on the back also. The artificial watermarks may be printed using clear dry ink. The artificial watermarks are represented as text outlines in a dashed line and characters as closed entities with a dot fill with no outline. The artificial watermark 202 may be any of number of shapes, sizes, colors, marking materials and marking material thickness.

Either beneath or overlaying artificial watermark 202 may be printed or marked other images or security images. The word overlay as subsequentially used should be taken to include lamination with another material, printed with ink jet or toner materials or other printing techniques.

A digitally applied artificial watermark is inherently variable and has the security characteristics of conventional lithographically artificial watermarks, i.e. not copyable and not overtly visible. In addition to those characteristics, a artificial watermark produced using a Kodak NexPress 2100 digital production color press, manufactured by NexPress Solutions, Inc. of Rochester, N.Y., is digitally variable, similar in removal resistance to other elements, and applied in the same machine printing pass as the other variable data on the document.

As is evident from FIG. 4, the variable artificial watermark may include static information such as “Original Document” like conventional artificial watermarks, that remains the same from document to document. In addition, the artificial watermark may include variable information that varies from document-to-document during printing. Variable information is document specific, for example the payee and the original amount of a check. If a fraudster alters the amount of a check and/or the payee, the intended amount and payee can still be determined by examining the variable data watermark. Altering the variable data watermark to match the altered amount and/or payee will be difficult or impossible for the fraudster. In this way the variable data watermark adds a very high degree of protection against fraud by alteration to a check or other high value document.

Often times, documents are printed for controlled distribution. By embedding variable data artificial watermarks with control information such as name of document recipient, copied documents can be easily detected.

Variable data artificial watermarks can be used in tandem with other security features, such as variable data microprinting to enhance document security. To this end, variable data artificial watermarks can be used in tandem with other security features, such as variable data microprinting watermarks to enhance document security.

Fonts suitable for microtext printing are are comprised of an array or pattern of pixels defined electronically in memory. Each pixel is a representation of approximately one six hundredth of an inch when printed (600 dpi). Of course, other printing resolutions are contemplated in the practice of the invention such as 800 or 1200 dpi, for example. When the fonts are printed, marked pixels bleed over or at least partially overlie certain unmarked pixels adjacent to marking pixels such that legible two point or less characters are rendered. (one point being nominally 1/72 of an inch, as is well known in the printing industry). According to a further aspect of the invention, one point or less characters may be rendered. “Legible” means that the characters are human readable, although generally and preferably with magnification, for example a low-power magnification. “Characters” includes alphanumeric characters, for example from the English, German, Spanish, Dutch, French, etc., alphabets and numbering systems. “Characters” also includes oriental human readable characters, for example Japanese and Chinese language characters.

The characters may be arranged in strings that convey human readable and understandable information, for example information about the document, the payor, the payee, the amount of a check, etc., without limitation, as may be desirable for a particular implementation.

A two point or less legible character may be rendered on a receiver by at least partially marking areas on the receiver corresponding to certain pixels and other areas on said receiver corresponding to the other pixels. According to a further aspect of the invention, one point or less characters may be rendered. The receiver may be a paper sheet, plastic sheet, the electrostatic imaging member 18, etc. According to the various aspects of the invention, legible alphanumeric characters having a height less than or equal to 0.028 inches ( 2/72 of an inch) and less than or equal to 0.014 inches ( 1/72 of an inch) may be printed. At 600 dpi, the font is nominally about 0.008 inches high to 0.012 inches high. With bleeding or over-marking of adjacent pixels, the marked font may be approximately 0.011 inches high depending upon exposure of the electrostatic imaging member 18, at least to some extent, as will be discussed. The height of the marked font may also be less than the nominal height.

The microprint characters are composed of horizontal single pixel lines, vertical single pixel lines, single pixel diagonal lines, and isolated pixels. The characters may be composed in this manner anticipating partial marking of the other pixels adjacent to the pixels so that a legible character results after marking. Vertical and horizontal lines of pixels may intervene with a mutually adjacent other pixel. The top and bottom horizontal lines intervene with the top and bottom, respectively, of a vertical line on the right side of the character. An intervening other pixel not indicated for marking is mutually adjacent the top horizontal line and the right vertical line, and another is mutually adjacent the bottom horizontal line and the right vertical line. In this way, legible characters are rendered. The microprinted characters may also be printed as an artificial watermark.

Further explanation of microprinted characters is provided in commonly owned U.S. patent application Ser. No. 10/991,818 entitled “PRINTING SYSTEM, PROCESS, AND PRODUCT WITH MICROPRINTING” and U.S. patent application Ser. No. 10/991,749 entitled “PRINTING SYSTEM, PROCESS, AND PRODUCT WITH A VARIABLE PANTOGRAPH”, both of which are hereby incorporated herein by reference.

Security of documents may be enhanced with variable data artificial watermarks incorporating information specific to the document, for example a negotiable instrument, such as payees name and amount or encrypted cypher code. A check, passport, high value gift certificate, insurance policy, stock certificate, drivers license, event ticket, warranty document, car title, or other high value document with the payee and/or amount serial number and/or other variable information associated with the document printed as a variable data artificial watermark would create a huge hurdle for a fraudster who wished to alter the check and have it go undetected.

In addition to being document specific, the variable data artificial watermark would be removed with the same difficulty as other information on the document. The Kodak NexPress 2100 digital production color press can be configured with multiple toning stations, including a fifth station that may be used to print digital variable artificial watermarks in accordance with the present invention. This fifth station can print with a clear dry ink which can be used to print the artificial watermark. The key variable data on a security document (name, payee, amount, birthdate, etc.) can be replicated as a variable data watermark on either the face, the back, or both of the document. The variable data watermark will be difficult or impossible to either change or copy. The variable data watermark is, therefore, an extremely powerful security feature. It offers strong protection against counterfeiting and copying, just like traditional watermarks. Variable data watermarks also offer strong protection against fraud by alteration. Variable data watermarks can therefore be used in tandem other security features, such as variable data microprinting and variable data micropimted watermarks, to enhance the fraud resistance of high value documents. In this way the use of microprinting also protects against copying, at least to some extent.

The present invention may be used in any type of digital printing system, such as electrostatographic, electrophotographic, inkjet, laserjet, etc. of any size or capacity in which pixel exposure adjustment value is selected prior to printing.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

### Parts List

10 printer machine
18 exposure medium
18a surface
19 variable power supply
20 motor
21a-21g rollers or other supports
24 logic and control unit
28 charging station
30 voltage controller
32 interface controller
34 exposure station
34a writer
35 development station
35′ station
35a backup roller
36 image data source
37 raster image processor
38 page memory buffer
38a multiple toning station
38b multiple toning station
39 image render circuit
40 programmable controller
42 toner auger
46 transfer station
46a programmable voltage controller
46b roller
48 cleaning station
49 fuser station
50 electrometer probe
52 backer bars
54 magnetic brush
56 mixture
58 rotating shell
60 magnetic poles
62 ground
64 member velocity
66 surface velocity
76 densitometer
100 mainframe
110 local user interface
202 watermark
204 security image
L length
P arrow
S receiver sheet
V voltage
Vb bias voltage

What is claimed is:

1. A document production process comprising printing an artificial watermark on a receiver, the artificial watermark comprising information specific to that document.

2. The process of claim 1, comprising varying said information specific to that document during printing from document-to-document.

3. The process of claim 1, comprising:
defining an array comprising pixels identified for marking and other pixels adjacent to said pixels which are not identified for marking; and,
printing a legible two point or less character on a receiver by at least partially marking areas on said receiver corresponding to said pixels and other areas on said receiver corresponding to said other pixels.

4. The process of claim 1, comprising digitally varying said artificial watermark.

5. The process of claim 1, said printing comprising printing with toner.

6. The process of claim 1, said printing comprising printing with clear color toner.

7. The process of claim 1, said printing comprising printing with color toner other than black.

8. The process of claim 1, said printing comprising printing with toner that fluoresces when exposed to ultraviolet radiation.

9. The process of claim 1, said printing comprising printing with toner that fluoresces when exposed to infrared radiation.

10. A document made by the process of claim 1.

11. The process of claim 1, wherein the artificial watermark is comprised of microprint.

12. The process of claim 11, comprising digitally varying said artificial watermark.

13. The process of claim 1, comprising:
printing said artificial watermark on said receiver with toner.

14. The process of claim 13, comprising digitally varying said character watermark.

15. A document production apparatus comprising:
an electrographic printer; and
a memory comprising instructions that control printing a artificial watermark on a receiver, said artificial watermark comprising information specific to that document.

16. The apparatus of claim 15, wherein said electrographic printer prints with toner.

17. The apparatus of claim 15, wherein said electrographic printer prints with clear color toner.

18. The apparatus of claim 15, wherein said electrographic printer prints with color toner other than black.

19. The apparatus of claim 15, wherein said electrographic printer prints with toner that fluoresces when exposed to ultraviolet radiation.

20. The apparatus of claim 15, wherein said electrographic printer prints with toner that fluoresces when exposed to infrared radiation.
